(19) United States
(12) Patent Application Publication
(10) Pub. No.: US 2006/0137537 A1
(43) Pub. Date: Jun. 29, 2006

(54) Suspension device and method of manufacturing thereof

(75) Inventor: Jeffrey P. Christensen, Algona, IA (US)

Correspondence Address: BARNES & THORNBURG, LLP, P.O. BOX 2786, CHICAGO, IL, 60690-2786, US

(73) Assignee: Cozzini, Inc.

(21) Appl. No.: 11/025,627

(22) Filed: Dec. 29, 2004

(51) Int. Cl. A21B 7/00

(52) U.S. Cl. 99/348

(57) ABSTRACT

A suspension device formed from an integral piece of material adapted to engage and support a product during processing and a method of manufacture. The suspension device includes a substantially flat plate member lying substantially in a first plane, a hook or support member and a plurality of tine members. The hook or support member extends integrally from the plate member and is adapted to allow the bacon comb to be suspended from an object. The plurality of tine members extend integrally from the plate member and are adapted to engage a product for support and suspension. The plurality of tine members lie substantially in a second plane that intersects the first plane. Optionally, the plate member may include one or more apertures through the plate member to provide for the passage of a locating or guide post there through, such that a plurality of suspension devices can be stacked.

### BACKGROUND OF THE INVENTION

The present invention relates to integrally formed devices for supporting, suspending and handling of articles, particularly meat products, in manufacturing and processing operations. More particularly, the present invention is concerned with improvements in bacon combs or bacon hangers for supporting, suspending and handling of pork bellies during processing operations.

In the commercial preparation of bacon, pork bellies are first separated from the rest of the hog carcass and appropriately trimmed or skinned. The pork bellies are then typically sent to a first processing area where the bellies are injected with a curing solution or brine. Upon leaving the brine injection area, the bellies are sent to a combing area where bacon combs are manually inserted into an end of the belly. The bacon combs provide for the support or suspension of the pork bellies from a tree, rack or conveyor while the bellies are being further processed, such as by smoking or cooking. After the pork bellies have been cooked, smoked or otherwise processed, the bellies are removed from the bacon comb and transported for further processing, such as slicing into strips. The bacon comb is washed and returned to the combing area for further use.

Conventional bacon combs known in the art comprise a plurality of welded metal rods. More particularly, the welded rod bacon combs comprise a number of curved, metal rods having sharpened points that form the prongs of the comb. The rods are welded to a separate metal rod frame member. A hook or otherwise shaped member is welded to the rod frame member to provide a means of hanging the bacon comb from a meat tree, overhead rail, or the like. Examples of welded rod bacon combs are described in U.S. Pat. Nos. 4,172,305 and 5,938,522.

These previous welded rod bacon combs have several shortcomings that meat processors desire to reduce or eliminate entirely. One such shortcoming is related to the structural integrity of the welded rod bacon combs when subjected to the multiple cycles of use and rough handling encountered in the bacon processing industry. The continuous, repetitive use of the welded rod bacon combs causes the welds securing the prongs and hooks to the frame member to become fatigued, thus cracking and/or failing altogether. When these welds crack or fail the prongs, or teeth, are prone to breaking away from the frame member and may remain in the bacon product upon separation of the bacon and the comb. Such unwanted breaking of prongs or teeth not only means the loss of the bacon comb, but also poses a significant risk of injury to downstream processing personnel and/or damage to downstream processing equipment, such as slicers, if the broken prong remains in the product. The fatigue and cracking often mean taking the comb out of service for repair, such as new welds, and other maintenance of the combs, which adds to the costs associated with using welded rod combs. The welds are also susceptible to rusting, which is undesirable and may cause discoloration of the bacon product.

Another shortcoming of the previous welded rod bacon combs is their poor stacking or nesting characteristics. A single bacon processing facility generally may have 10,000 to 100,000 bacon combs in continuous service at one time. The bacon combs should be capable of easy and orderly stacking on comb racks for the meat processor to handle and transport the numerous bacon combs between process areas and during the processing of the bacon combs themselves, such as during washing. Additionally, if an automatic bacon combing apparatus is used for impaling the pork bellies, the bacon combs must be easily stacked in the comb feeding magazine and easily dispensed to the automatic combing apparatus. During the continuous and cyclic use of welded rod bacon combs, the prongs and hooks are bent and take on irregular shapes. This deviation from a regular shape prevents the combs from stacking in a secure and orderly fashion. As the prongs and hooks or handle members become bent, they may easily become entangled with adjacent combs.

Also, since the bacon combs are recycled in the bacon processing operation, the bacon combs must be periodically washed. Washing is usually accomplished by manually spraying the combs with a special cleaning solution followed by rinsing the combs while the bacon combs are stacked on a bacon comb rack. The same may be accomplished in a mechanical washer. The previously known welded wire rod bacon combs are difficult to clean due to the poor stacking and the intricate intersection of the metal rods. These intersections provide crevices or tight areas where matter may collect, thereby making it difficult to remove effectively. Additionally, cracks that form in the welds provide for additional collection of matter that is difficult to remove. Incomplete removal of this collected matter during washing leads to potentially unsanitary conditions.

A further shortcoming of welded rod bacon combs relates to ergonomic qualities of the combs. Bacon combs are still manually inserted into the pork bellies at many processing facilities. The combing personnel shape-up the pork bellies and engage the belly with the prongs or tines of the bacon comb and physically force the comb into the pork belly flesh. The previous welded rod bacon combs present an ergonomic problem for the personnel since the narrow metal rods provide a minimum area on which to apply pressure, which can lead to repetitive motion injuries.

Consequently, there exists a well recognized need for an improved bacon comb which will eliminate, or at least greatly reduce, the shortcomings encountered with the use of heretofore known bacon combs. It is therefore an object of the present invention to provide an improved bacon comb that overcomes, or at least greatly reduces, the problems associated with known bacon combs. The advantages of the present invention will be apparent from the following description, the accompanying drawings and the appended claims.

### SUMMARY OF THE INVENTION

The present invention comprises a suspension device formed from an integral piece of material and adapted to, engage and support a product during processing. The suspension device includes a flat plate member lying in a first plane, a hook or support member and a plurality of tine members. The hook or support member extends integrally from the plate member and is adapted to allow the bacon comb to be suspended from another object or surface. The plurality of tine members extend integrally from the plate member and are adapted to engage a product for support and suspension. The plurality of tine members lie substantially in a second plane that intersects the first plane. Optionally, the plate member may include one or more apertures through the plate member to provide for the passage of a locating or guide post therethrough, such that a plurality of suspension devices can be stacked.

The suspension device provided by the present invention is made integrally from a single piece of material, thereby eliminating the need for welded parts and the inherent shortcomings associated therewith. The more important features of the invention have been outlined in order that the detailed description that follows may be better understood and in order that the present contribution to the art may be more fully appreciated. The advantages of the invention will become more apparent upon consideration of the preferred embodiments which are illustrated in the accompanying drawings wherein like parts are identified by the same numerals throughout the views.

### BRIEF DESCRIPTION OF THE DRAWINGS

FIG. 1 is a perspective view of a preferred bacon comb according to the invention, with a pork belly being shown in phantom line so as to illustrate the use of the comb in the handling of pork bellies.

FIG. 2 is a bottom view of the bacon comb of FIG. 1, shown without the phantom pork belly.

FIG. 3 is an end view of the bacon comb depicted in FIG. 1, with a pork belly being shown in phantom line.

FIG. 4 is a four-part schematic illustrating the steps taken in forming an integral suspension device according to the invention.

### DETAILED DESCRIPTION OF THE PREFERRED EMBODIMENTS OF THE INVENTION

While the present invention will be described fully hereinafter with reference to the accompanying drawings, in which a particular embodiment is shown, it is to be understood at the outset that persons skilled in the art may modify the invention herein described while still achieving the desired result of this invention. Accordingly, the description that follows is to be understood as a broad informative disclosure directed to persons skilled in the appropriate art and not as limitations of the present invention.

As illustrated in the drawings, a suspension device according to the present invention, in the form of a bacon comb 10, is designed for use in suspending products, particularly pork bellies, during handling and processing of the product. The bacon comb 10 is designed such that it may engage a pork belly and thereafter be hung on a rack or the like and transported to a further processing area, or suspended from or carried by a conveyor, rail, or the like.

The bacon comb 10 is formed integrally from a single piece of material, such as a sheet of eleven gauge 304 stainless steel or other structurally suitable material. Stainless steel is preferred for its strength and resistance to the many environments encountered during the processing of meat products. It is also easily cleaned and of pleasant appearance. Forming the bacon comb 10 from a single sheet of material eliminates the necessity of the several welds required to form the heretofore known metal rod bacon combs. The elimination of welded parts provides for a stronger, longer lasting bacon comb and also greatly reduces the risk of injury or machinery damage due to broken metal rod prongs. The substantially flat bacon comb free of welds is more efficiently cleaned since the intricate metal rod intersections, where material is prone to collect, have been eliminated. Also, the larger, smooth area on which manual combing personnel may apply pressure is more ergonomic for the combing personnel.

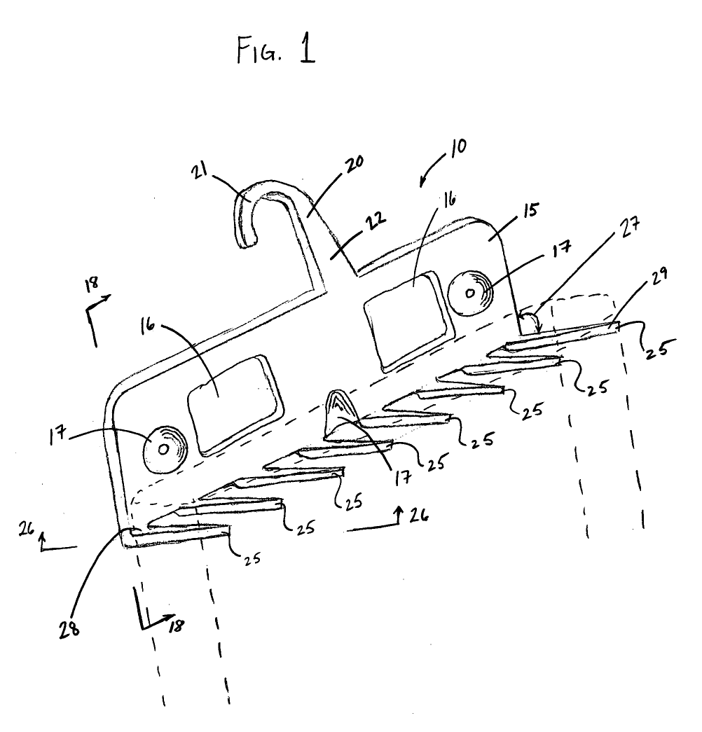

Best shown in FIG. 1, the bacon comb includes a plate member 15 that generally serves as the structural frame of the bacon comb 10. Preferably, the plate member 15 includes at least one aperture 16 to provide for the passage of a guide post (not shown) such that a plurality of bacon combs 10 may be stacked in a secure and orderly fashion on a comb rack or in a feeding magazine for an automatic combing apparatus. Two apertures 16 are shown in the figures formed in the general shape of a rectangle with rounded corners. Any shape or form may be used that provides for a guide post of complimentary shape or form to pass through the aperture. Preferably, the plate member 15 further includes a plurality of embossments 17a-c that provide for spacing and proper nesting between adjacent combs when stacked and also facilitate the removal of the comb from the bacon. Embossments 17a and 17b are shown in partially spherical depressions positioned within the plate member 15 outwardly from the apertures 16 in the figures. Embossment 17c is shown as a wedge-like depression placed at a lower edge of the plate member 15. The increased spacing allows for more efficient cleaning of the bacon combs during the washing process.

The bacon comb 10 further includes a support member 20. The support member 20 extends integrally from the plate member 15 and is preferably formed in the shape of a hook 21. Those skilled in the art will appreciate that the support member may take any form, including that of an aperture, such that the support member allows for the suspension of the bacon comb 10 from another object. The hook 21 preferably includes a neck portion 22 having a first end adjacent the plate member 15 and a second end opposite the first end, wherein the first end has a width greater than the second end width to provide extra strength at the juncture of the plate member 15 and the support member 20.

The bacon comb further includes a plurality of tine members 25. The plurality of tine members 25 extend integrally from the plate member 15 at a side generally opposite the support member 20. The number of tine members 25 may vary depending on the product to be supported. Pork bellies are approximately 13 inches in width at the end in which the bacon comb is inserted. It has been found that placing the tine members 25 approximately one inch apart is suitable. The figures depict a bacon comb 10 with eight tine members 25, however any number may be used. The plurality of tine members 25 are bent at or near their intersection with the plate member 15 such that they lie in a second plane 26 that intersects a first plane 18 formed by the plate member 15. Preferably the second plane 26 forms an acute included angle 27 at the intersection with the plate member 15. The acute included angle 27, ensures that the tine members point slightly upwardly when the comb 10 is hung by the hook 21, thus preventing the pork bellies from sliding off the bacon comb 10 during processing. Preferably, the acute included angle 27 comprises an angle of about 65° to about 85°, with an angle of 75′ most preferred.

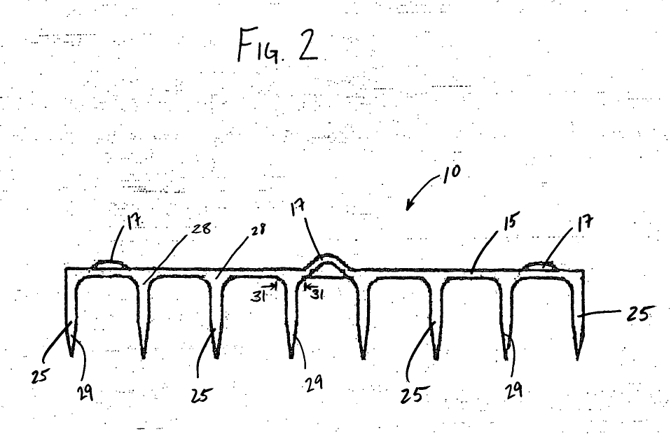

Each of the plurality of tine members 25 include a base portion 28 located adjacent the plate member 15. As best seen in FIG. 2, the base portion 28 includes a first width adjacent the plate member 15 and a second width opposite the first width, wherein the first width is greater than the second width. Thus, the base portion includes an increased width or radius shown by lines 31 that provides for additional strength and thus greatly reduces the risk that a tine member 25 will be separated or broken away from the bacon comb 10. Previous combs used welds to attach prongs or tines which welds fatigue over the life of the comb and may ultimately fail creating potential hazards as previously discussed. By eliminating the need for welding and adding additional width to the juncture of the tine members 25 and plate member 15, the tine members 25 are stronger and much less likely to break off. Preferably, each of the plurality of tine members 25 is provided with a tapered point 29 formed by tapering the sides of the tine member 25. The tapered point 29 provides for ease of insertion of the plurality of tine members 25 into a product. The length of the tine members 25 may vary depending on the product to be supported. A length of about 1 and ⅞ inches has been found suitable for use with pork bellies; however, other lengths may be more suitable for different product thicknesses.

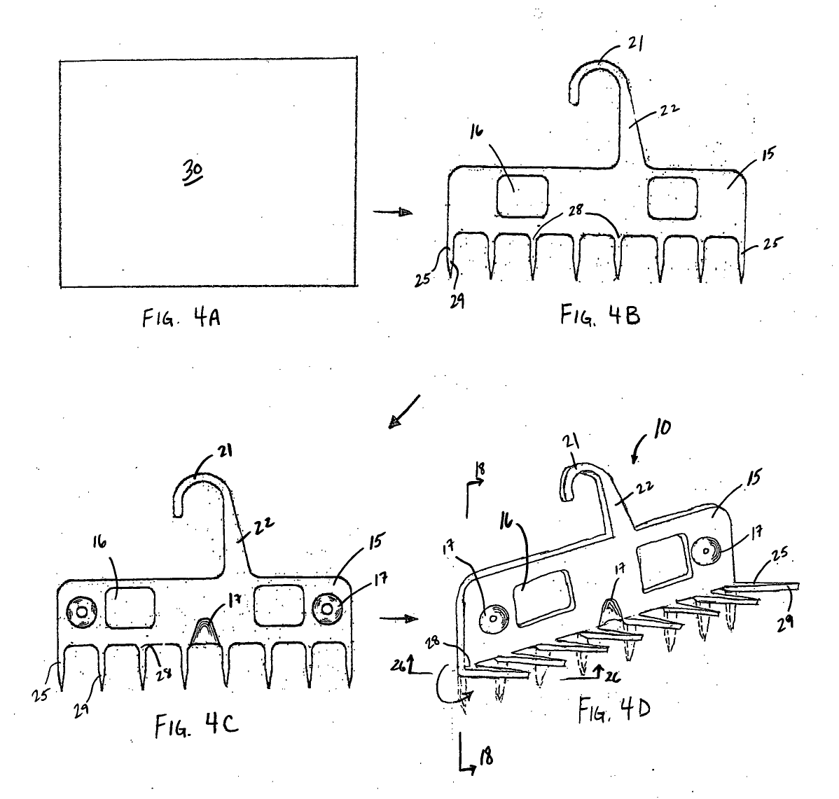

The bacon comb 10 is preferably formed through a series of punching or cutting and bending operations. FIGS. 4 A-D depict a schematic of the preferred steps taken in manufacturing the bacon comb 10. A sheet of material 30 (FIG. 4A), preferably eleven gauge 304 stainless steel although other thicknesses may be used, is first punched or cut to remove the material that will not form a part of the bacon comb 10. The punching or cutting step defines or forms the plate member 15, the support member 20 and the plurality of tine members 25 (FIG. 4B). Preferably in the same punching step, at least one aperture 16 is provided in the plate member. Preferably, embossments 17 A-C are provided in the plate member contemporaneously with the punching/forming of the plate member 15, support member 20 and plurality of tine members 25 (FIG. 4C).

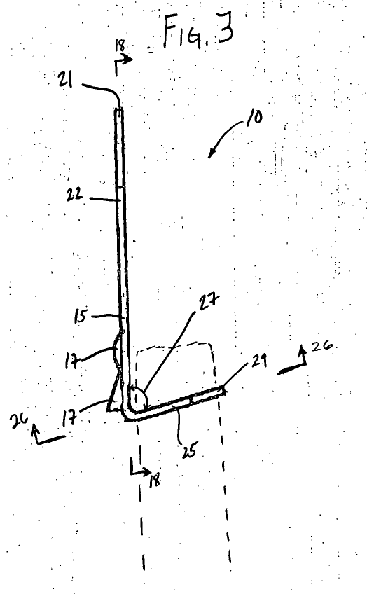

The last step in the process (FIG. 4D) comprises bending the plurality of tine members 25 such that they lie in the second plane 26 that intersects the first plane 18 formed by the plate member 15. This step is generally accomplished by holding either the plate member 15 or the plurality of tines members 25 stationary, while physically forcing the non-stationary member to rotate about a fixed point, such as the edge of a metal plate. Preferably, the member which is physically rotated is rotated more than 90 degrees such that an acute included angle 27 (best seen in FIG. 3) is formed between the first plane 18 and second plane 26. One skilled in the art will appreciate that the plurality of tine members 25 should form an acute angle with respect to the vertical plane when the bacon comb 10 is suspended from an object, whether or not the plate member 15 substantially assumes an exact vertical orientation. In this manner, the tine members 25 are presented in an upward pointing arrangement which prevents the pork belly from sliding off during processing.

Various features of the invention have been particularly shown and described in connection with the illustrated embodiments of the invention, however, it must be understood that these particular embodiments merely illustrate and that the invention is to be given its fullest interpretation within the terms of the appended claims.

What is claimed is:

1. An integrally formed suspension device adapted to engage and support a product during processing comprising:
a plate member lying in a first plane;
a support member extending integrally from said plate member and adapted to allow said device to be suspended from an elevated point; and,
a plurality of tine members extending integrally from said plate member, said plurality of tine members lying in a second plane that intersects said first plane.

2. The suspension device of claim 1, wherein said support member is formed in the shape of a hook.

3. The suspension device of claim 1, wherein said second plane intersects said first plane to form an acute included angle.

4. The suspension device of claim 2, wherein said support member formed in the shape of a hook includes a neck portion adjacent said plate member, said neck portion having a first end adjacent said plate member and a second end opposite said first end, said first end having a width greater than said second end.

5. The suspension device of claim 1, wherein said plate member includes one or more apertures to provide for the passage of a guide post such that a plurality of said suspension devices can be stacked at a designated position in a designated orientation.

6. The suspension device of claim 1, wherein said plurality of tine members include a base portion adjacent said plate member, said base portion having a first width adjacent said plate member and a second width opposite said first width, said first width being greater than said second width.

7. The suspension device of claim 1, wherein said plate member includes one or more embossments that extend outward from said first plane to provide spacing between adjacent suspension devices when a plurality of said suspension devices are stacked.

8. The suspension device of claim 7, wherein said plate member includes three embossments and one of said three embossments is provided along an edge between two of said plurality of tine members.

9. The suspension device of claim 2, wherein said plate member includes two apertures adapted to provide for the passage of guide posts.

10. The suspension device of claim 1, wherein said suspension device includes eight tine members extending integrally from said plate member.

11. The suspension device of claim 1, wherein each of said plurality of tine members includes a tapered point.

12. The suspension device of claim 1, wherein said device is formed from a sheet of metal.

13. The suspension device of claim 1, wherein said device is formed from a sheet of stainless steel.

14. A method of forming a unitary suspension device adapted to engage and support a product during processing comprising the steps of:
providing a sheet of material;
cleaving said sheet of material to form a plate member, a support member extending integrally from said plate member and a plurality of tine members extending integrally from said plate member, whereby said plate member lies in a first plane; and,
bending said suspension device at a point between said plate member and said plurality of tine members such that said plurality of tine members lie in a second plane that intersects said first plane.

15. The method of claim 14, wherein said sheet of material comprises a sheet of stainless steel.

16. The method of claim 14, wherein said cleaving step is performed by a punch press.

17. The method of claim 14, wherein said cleaving step includes forming one or more apertures in said plate member to provide for the passage of a guide post.

18. The method of claim 14, further including the step of forming embossments in said plate member in one or more areas.

19. The method of claim 14, wherein said support member is formed in the shape of a hook.

20. The method of claim 14, wherein said second plane intersects said first plane to form an acute included angle.
